(19) United States
(12) Patent Application Publication
(10) Pub. No.: US 2014/0372335 A1
(43) Pub. Date: Dec. 18, 2014

(54) Cooperative Path Tracking

(71) Applicant: International Business Machines Corporation, Armonk, NY (US)

(72) Inventors: Christopher P. Jones, Las Vegas, NV (US); Jonathan Lenchner, North Salem, NY (US); Nathan E. Masters, Henderson, NV (US)

(21) Appl. No.: 13/920,292

(22) Filed: Jun. 18, 2013

(51) Int. Cl. G06Q 10/08

(52) U.S. Cl. CPC G06Q 10/0833
USPC 705/333

(57) ABSTRACT

An approach is provided in which a tracking device is attached to an object and receives nearby object routes from multiple nearby tracking devices, each attached to respective nearby objects. The tracking device compares an expected route corresponding to the object with the received nearby object routes to determine whether the object is being transported along the expected route. When the tracking device determines that the object has been incorrectly routed, the tracking device generates a notification.

### BACKGROUND

The present disclosure relates to a distributed object tracking approach that utilizes a self-sufficient tracking device attached to an object, which indicates a deviation to the object's expected route by comparing the object's expected route to expected routes of nearby objects.

The process of transporting and routing individual objects, such as packages, luggage, etc., from multiple disparate locations to other disparate locations is an integral part of the modern global economy. This process is instrumental to global shipping, where packages are transported by ship, airplane, and truck, and pass through multiple sorting facilities as they move from a shipping location to a destination location. Each time a package moves to a new conveyance or sorting facility, a risk exists that the package will be routed incorrectly.

Similar issues apply in other scenarios, such as routing luggage at airports. With numerous pieces of luggage each being routed through numerous paths to disparate destinations, many pieces of luggage are misrouted, lost, or delayed, causing trouble and annoyance for many travelers.

### BRIEF SUMMARY

According to one embodiment of the present disclosure, an approach is provided in which a tracking device is attached to an object and receives nearby object routes from other nearby tracking devices, each attached to respective nearby objects. The tracking device compares an expected route corresponding to the attached object with the received nearby object routes to determine whether the object is being transported along the expected route. When the tracking device determines that the object has been incorrectly routed, the tracking device generates a notification accordingly.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 depicts a diagram of a self-sufficient tracking device that indicates when an attached object deviates from the object's expected route;

FIG. 2 depicts a diagram of a loading device that loads an expected route corresponding to an object into a tracking device;

FIG. 3A depicts a diagram showing a tracking device receiving nearby object routes while in transit from nearby tracking devices attached to nearby objects;

FIG. 3B depicts a diagram showing a tracking device receiving facility data while located at a sorting facility;

FIG. 4 depicts a diagram of vehicles shipping objects from source locations (shipping locations) to a sorting facility;

FIG. 5 depicts a diagram of vehicles shipping objects from a sorting facility to destination facilities; and

FIG. 6 depicts a flowchart showing steps taken in a tracking device monitoring an attached object's route progression.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

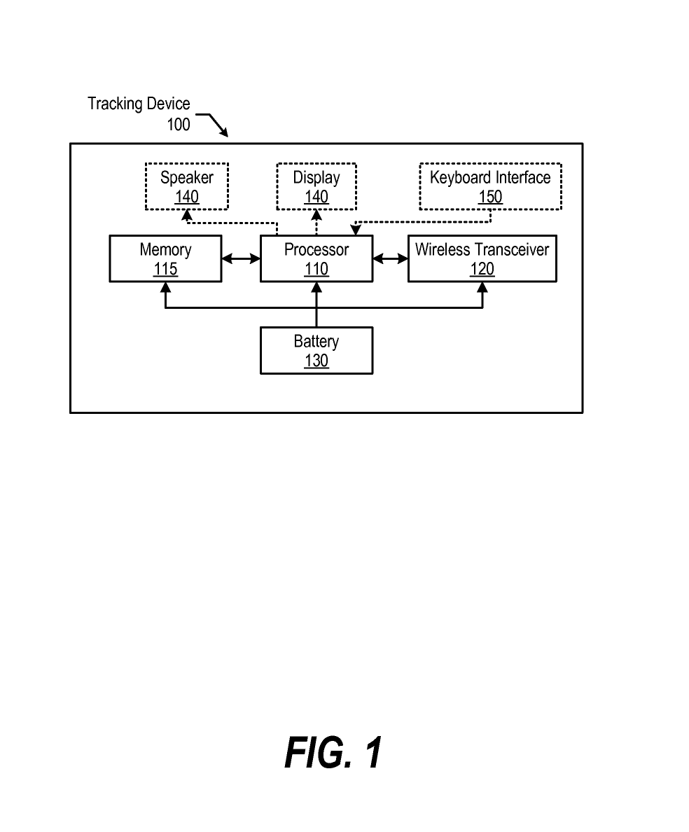

FIGS. 1-6 disclose a system that uses tracking devices attached to objects to monitor the objects' in transit progression. As discussed herein, an object is a physical item that is transported from a source location (shipping location) to a destination location, such as a package, luggage, etc. In one embodiment, a tracking device incorporates a preferably low-power microprocessor, data storage device, low-power wireless transceiver, and a data interface, such as that shown in FIG. 1. When an object is received at a facility and routed for transport, the object's expected route (e.g., location A->location B->location C) is input into the tracking device and the tracking device is attached to the tracked object.

While the object is en route to the object's destination, the tracking device receives nearby object routes from nearby tracking devices attached to nearby objects. The tracking device parses the nearby object routes to determine if the received nearby object routes overlap the object's expected route. If the object's expected route does not overlap a required percentage of the nearby object routes in the same route segment, the tracking device generates a notification that the object is off route, such as sounding an alarm condition that may include transmitting an alarm signal for reception by a control system, invoking an audio alert, an email, a SMS message, or an alarm display on an integrated e-ink screen or other display device.

In one embodiment, a control system in a sorting facility along the object's route may be configured to transmit an email, SMS message, or other appropriate means of notification to object handlers or other individuals in a position to identify the device with an alarm condition and take appropriate action. The use of an audio alert and alarm display assists object handlers in determining which of a number of objects has encountered an alarm condition.

In another embodiment, facilities along the route of travel can be equipped with transmitters that transmit facility data (e.g., the name of a city, airport or train station) to objects that, in turn, compare the facility data to expected route waypoints while also monitoring the amount of time that the object is located within a particular sorting facility.

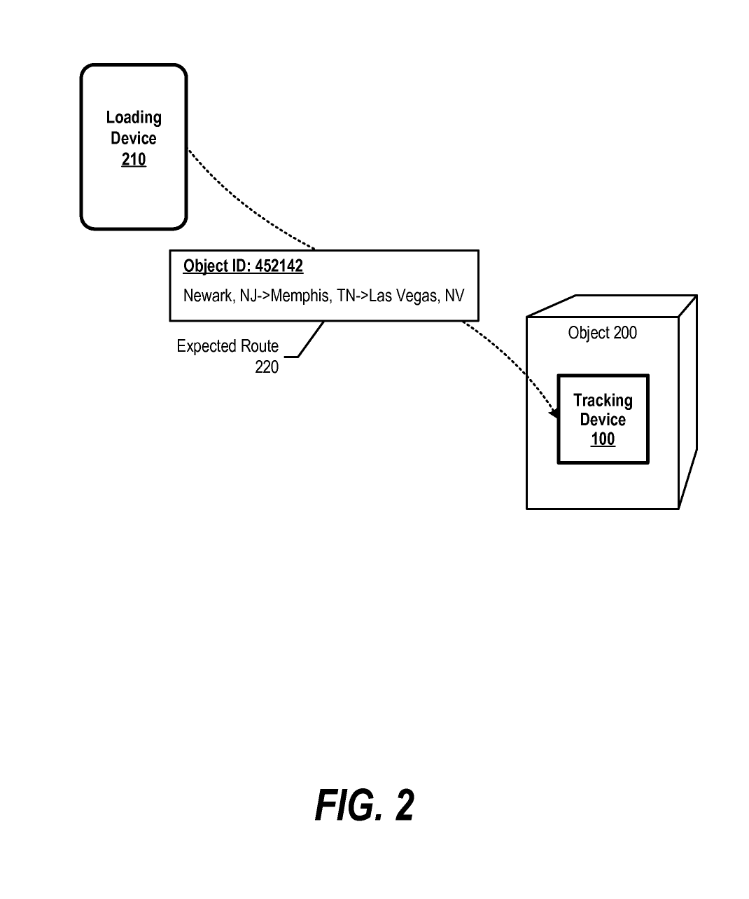

FIG. 1 depicts a diagram of a self-sufficient tracking device that indicates when an object to which the tracking device is attached deviates from the object's expected route. Tracking device 100, in one embodiment, includes battery 130, processor 110, memory 115, and wireless transceiver 120. Processor 110 may be a low-power microprocessor or low-power micro controller. Memory 115 is a low power data storage area (e.g., non-volatile memory) that processor 110 uses to store an object's expected route. Wireless transceiver 120, in one embodiment, receives the object's expected route from an itinerary loading device at the object's starting location, which processor 110 stores in memory 115 (see FIG. 2 and corresponding text for further details).

When the object is in transit, wireless transceiver 120 receives nearby object routes from nearby tracking devices that are attached to nearby objects. Processor 110 compares the nearby object routes with the stored expected route to determine whether the route of the associated object deviates from the object's expected route. Processor 110 also uses wireless transceiver 120 to transmit the object's stored expected route to nearby tracking devices, which the nearby tracking devices use as a nearby object route to compare against their own expected route.

In one embodiment, tracking device 100 includes keyboard interface 150 (or a keypad), which allows an operator to enter an object's expected route into tracking device 100. In another embodiment, tracking device 100 includes an audio device, such as speaker 140, which provides an audible notification that an object has diverted from the object's expected route. For example, processor 110 may send an audible signal to speaker 140 every ten seconds when processor 110 determines that the “route overlap” between the nearby object routes and the expected route is insufficient.

In yet another embodiment, tracking device 100 includes display 140, which provides a visual notification that the object has diverted from the object's expected route (e.g., a flashing light).

As those skilled in the art can appreciate, although tracking device 100 is one type of information handling system, other types of information handling systems may be utilized, which include a processor and memory, to perform the computing operations discussed herein.

FIG. 2 depicts a diagram of a loading device that loads an expected route corresponding to an object into a tracking device. Tracking device 100 is attached to object 200, which may be a package, luggage, or other item that is transported from a source location to a destination location. Loading device 210 may be a hand held electronic device that loads expected route 220, which is the expected shipping route of object 200, into tracking device 100, which tracking device 100 stores in memory 115. In one embodiment, loading device 210 may be a wireless device that loads expected route 220 into tracking device 100 via wireless transceiver 120. In another embodiment, loading device 210 may be a keyboard that communicates with tracking device 100 via keyboard interface 150 to load expected route 220 into tracking device 100.

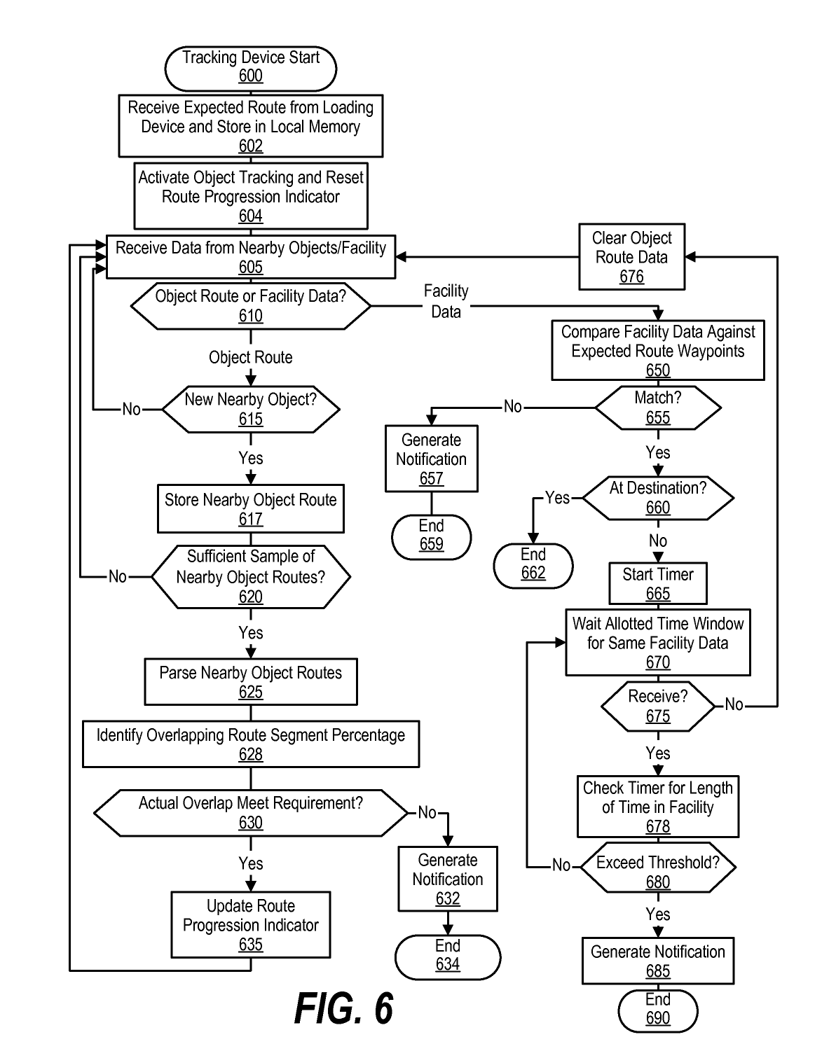

Expected route 220 shows that object 200 is expected to travel from Newark, N.J., to Memphis, Tenn., to Las Vegas, Nev. Tracking device 100 parses expected route 220 into expected route segments, which are 1) Newark, N.J.->Memphis, Tenn., and 2) Memphis, Tenn.->Las Vegas, Nev. As such, tracking device 100 uses a route progression indicator to determine which one of the expected route segments to compare against nearby object routes received while in transit (see FIG. 6 and corresponding text for further details).

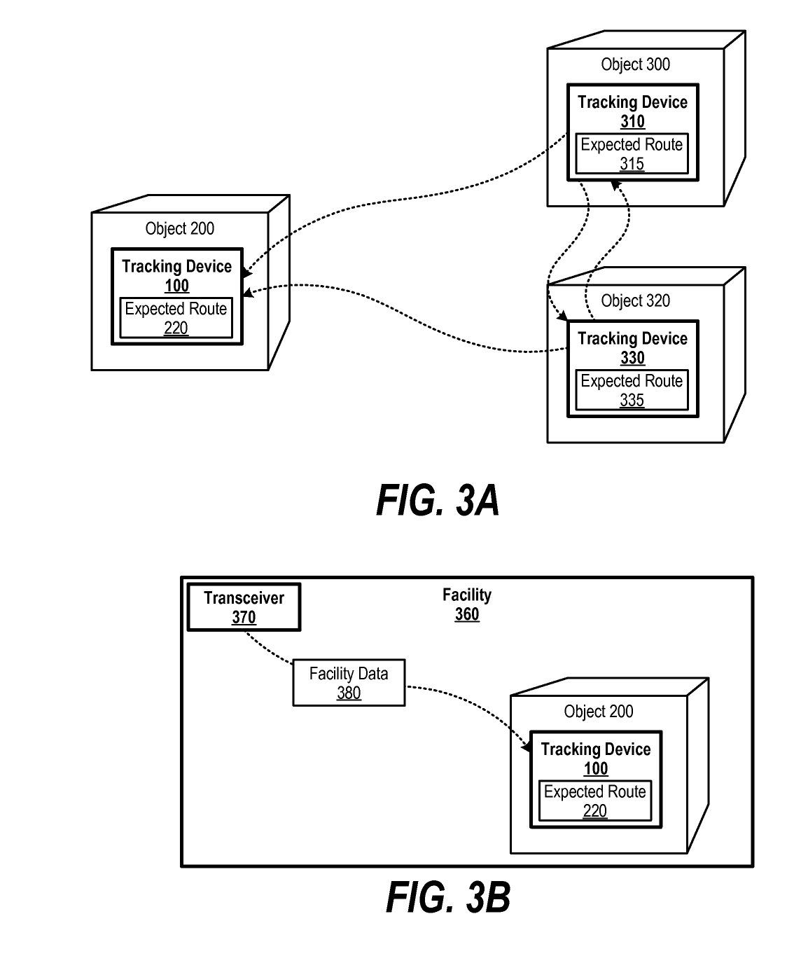

FIG. 3A depicts a diagram showing a tracking device receiving nearby object routes while in transit from nearby tracking devices attached to nearby objects. Tracking device 100 includes expected route 220 (from FIG. 2). As object 200 is transported, object 200 comes in proximity to other objects, such as object 300 and object 320, referred to herein as “nearby objects.” Tracking device 310 is attached to object 300 and includes object 300's expected route 315. Tracking device 330 is attached to object 320 and includes object 320's expected route 335.

Tracking device 310 broadcasts expected route 315 for other tracking devices to receive, which is received at tracking device 100 as a nearby object route. Likewise, tracking device 330 broadcasts expected route 335 for other tracking devices to receive, which is received at tracking device 100 as another nearby object route. The broadcasted expected routes (nearby object routes) include an object identifier corresponding to their respective tracking devices (or objects) such that tracking device 100 can distinguish received nearby object routes from each other.

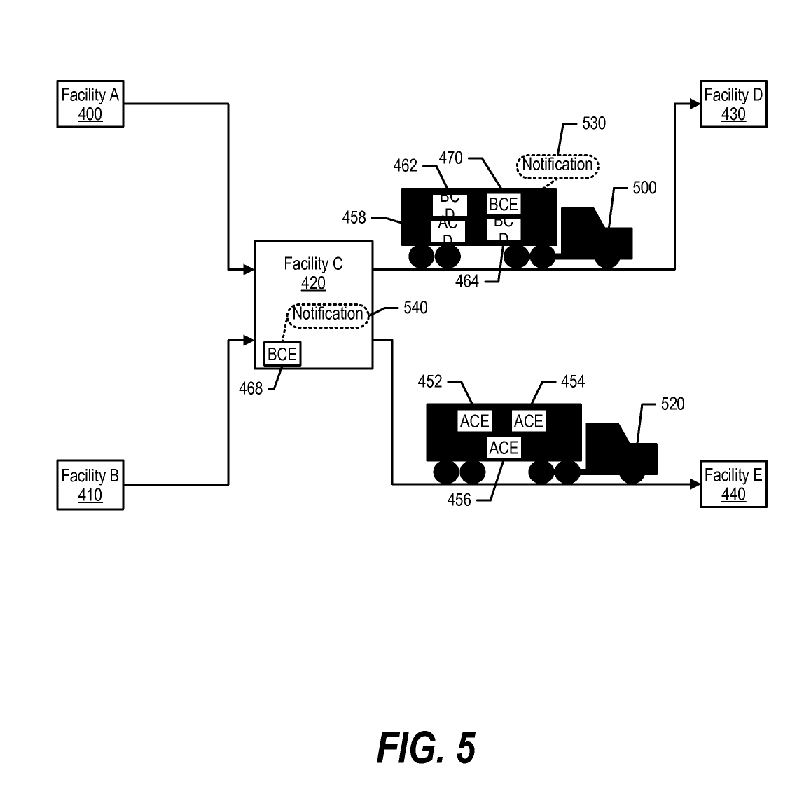

FIG. 3B depicts a diagram showing a tracking device receiving facility data while located at a sorting facility. Object 200 enters sorting facility 360, and receives facility data 380 from transceiver 370. Facility data 380, in one embodiment, includes location information of sorting facility 340 (e.g., Memphis, Tenn.). As such, tracking device 100 compares facility data 380 with waypoints included in expected route 220 to determine whether object 200 is being shipped according to expected route 220. In one embodiment, tracking device 100 invokes a timer when receiving facility data 380 to track the amount of time that object 200 remains in sorting facility 360 (see FIGS. 5, 6, and corresponding text for further details).

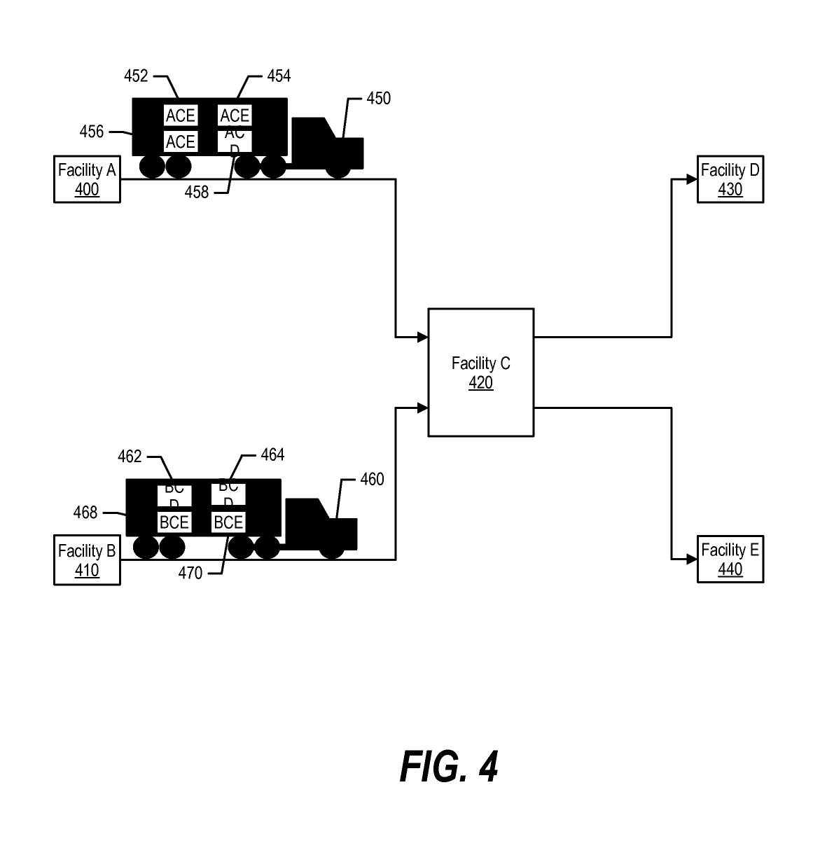

FIG. 4 depicts a diagram of vehicles shipping objects from source locations (shipping locations) to a sorting facility. FIG. 4 depicts facilities 400, 410, 430, and 440 that, in one embodiment, are source/destination facilities at which objects are shipped/received. Facility 420 is a sorting facility that transfers objects between transport vehicles (e.g., truck, ship, plane, etc.), which transport the objects to destination facilities.

Vehicle 450 includes objects that commence at facility 400 with expected destinations at either facility D 430 (“ACD” expected route) or facility E 440 (“ACE” expected route). FIG. 4 depicts tracking devices 452, 454, 456, and 458, which are attached to their respective objects. Tracking devices 452, 454, and 456 have expected routes A->C->E, and tracking device 458 has expected route A->C->D. Since each of the tracking devices have an expected route of A->C, each of the tracking devices receive nearby object routes from the other tracking devices included in vehicle 450 and determine that each tracking device's corresponding object is on their expected route while vehicle 450 transports their respective objects from facility A 400 to facility C 420.

Likewise, vehicle 460 includes objects that commence at facility B 410 with expected destinations at either facility D 430 (“BCD” expected route) or facility E 440 (“BCE” expected route). FIG. 4 depicts tracking devices 462, 464, 468, and 470, which are attached to their respective objects. Tracking devices 462 and 464 have expected routes B->C->D, and tracking devices 468 and 470 have expected routes B->C->E. Since each of the tracking devices have an expected route of B->C, each of the tracking devices receive nearby object routes from the other tracking devices included in vehicle 460 and determine that each tracking device's corresponding object is on their expected route while vehicle 460 transports their respective objects from facility A 400 to facility C 420.

When vehicles 450 and 460 reach facility C 420, their respective objects are unloaded and sorted in facility C 420. During this time, in one embodiment, facility C 420 broadcasts facility data that is received by each of the tracking devices, which informs the tracking devices of their current location in facility C 420. Since each of the tracking devices' expected route includes facility C 420 as a waypoint (ACE, ACD, BCD, BCE), each tracking devices determines that its respective object is still on the object's expected route. In one embodiment, each tracking device starts a timer to monitor the amount of time that the tracking device remains in facility C 420 (see FIGS. 5, 6, and corresponding text for further details).

FIG. 5 depicts a diagram of vehicles shipping objects from a sorting facility to destination facilities. Continuing from the discussion of FIG. 4, once the objects are sorted in facility C 420, the objects are placed in vehicle 500 or vehicle 520 for destinations of facility D 430 or facility E 440, respectively. Vehicle 500 includes objects corresponding to tracking devices 458, 462, 464, and 470.

Tracking devices 458, 462, and 464 have an expected route segment of C->D. However, tracking device 470 has an expected route segment of C->E. As tracking devices 458, 462, 464, and 470 broadcast their expected routes to each other (e.g., received as nearby object routes), tracking devices 458, 462, and 464 determine that they are on their expected route because the majority of received nearby object routes include a route segment that matches an expected route segment included in their corresponding expected route. For example, tracking device 462 receives nearby object routes from tracking devices 458, 470, and 464. Two of the nearby object routes (from tracking devices 458 and 464) include a route segment that matches tracking device 462's expected route (C->D), whereas one of the nearby routes includes a different route segment (C->E from tracking device 470). As such, tracking device 462 determines that it's attached object is being transported according to its expected route. The same holds true form tracking devices 458 and 464.

However, when tracking device 470 receives nearby object routes from tracking devices 458, 462, and 464, tracking device 470 determines that its attached object has deviated from its expected route because none of the received object routes include a route segment matching tracking device 470's expected route segment of C->E. As such, tracking device 470 generates notification 530, which may be an audible alarm, a visual alarm, and/or a wireless message. In turn, an operator may be notified of the misrouted object before vehicle 500 leaves facility C 420, thus enabling the operator to retrieve the misrouted object and place the object on the correct vehicle.

Vehicle 520 includes objects corresponding to tracking devices 452, 454, and 456, which all have expected route segments of C->E. Each of tracking devices 452, 454, and 456 receive nearby object routes from their nearby tracking devices and each determine that they are on course of their expected route.

FIG. 5 also shows that an object corresponding to tracking device 468 remains at facility C 420 because, for example, the object fell off a conveyor belt or stuck somewhere in the sorting process. When tracking device 468 entered facility C 420, tracking device 468 received facility data that was broadcasts by facility C 420 to inform tracking device 468 that tracking device 468 arrived at facility C 420. As such, tracking device 468 invoked a timer to track the amount of time that it remains in facility C 420. Tracking device 468 compares the tracked amount of time with a predetermined facility timeframe threshold (e.g., four hours) and, when tracking device 468's amount of time spent in facility C 420 exceeds the facility timeframe threshold, tracking device 468 generates notification 540, which may be an audible alarm, a visual alarm, and/or a wireless message. As such, an operator is able to locate tracking device 468's object and route it accordingly.

FIG. 6 depicts a flowchart showing steps taken in a tracking device monitoring an attached object's route progression. Tracking device processing commences at 600, whereupon the tracking device process receives an expected route corresponding to the object on which the tracking device is attached (step 602). In one embodiment, the tracking device process receives the expected route through a wireless signal via wireless transceiver 120 shown in FIG. 1. In another embodiment, the tracking device process receives the expected route through keypad interface 150 shown in FIG. 1. The tracking device process stores the expected route in memory 115, which the tracking device process utilizes to compare against nearby object routes and facility data received while the object is in transit (discussed below).

At step 604, the tracking device process activates object tracking and resets a route progression indicator. The tracking device process utilizes the route progression indicator to track the progress of the tracking device's attached route progression through route segments and waypoints (e.g., facility locations). As such, the tracking device process knows which one of the expected route's segments to compare against received nearby object routes (discussed below). The route progression indicator may be, for example, a pointer, a register value indicating a route segment (e.g., segment “2”), etc.

During the object's transport, the tracking device process receives data over a wireless connection via wireless transceiver 120. The data may originate from nearby tracking devices attached to nearby objects (e.g., while on a transport vehicle), or the data may originate from a facility transceiver (e.g., while located within a sorting facility). In one embodiment, the tracking device process broadcasts a request message to invoke nearby tracking devices to send their corresponding expected route (received as a nearby object route).

The tracking device process receives data at step 605, and a determination is made as to whether the data is a nearby object route or facility data (decision 610). In one embodiment, the tracking device process determines the data type by extracting a device identifier from the received data that generated the data (e.g., a tracking device identifier or a facility identifier).

If the data was generated by a nearby tracking device, decision 610 branches to the “Object Route” branch, whereupon the tracking device process determines whether the route was provided by a newly discovered nearby tracking device (decision 615). This prevents the tracking device process from storing a nearby object route multiple times from the same nearby tracking device.

If the tracking device previously stored the received nearby object route, decision 615 branches to the “No” branch, which loops back to monitor and receive more data. This looping continues until the tracking device process receives a new nearby object route, at which point decision 615 branches to the “Yes” branch, whereupon the tracking device process stores the nearby object route in memory 115 at step 617.

The tracking device process determines whether the tracking device has received a sufficient number of nearby object routes from different nearby tracking devices to analyze route progression (decision 620). For example, the tracking device process may wait until it receives nearby object routes from a minimum of six different nearby tracking devices before beginning to analyze the tracking device's expected route. In an embodiment where the tracking device process broadcasts a request message, the tracking device collects nearby object routes for a predetermined amount of time before proceeding with the expected route analysis process.

If the tracking device process determines that enough nearby object routes have not yet been collected, decision 620 branches to the “No” branch, whereupon the tracking device process loops back to receive more data. This looping continues until the tracking device stores a sufficient amount of nearby object routes, at which point decision 620 branches to the “Yes” branch.

At step 625, the tracking device process parses each nearby object route into route segments. For example, nearby object route data may include A->B->C, in which case the tracking device process parses the nearby object route data into segments A->B and B->C. At step 628, the tracking device process identifies the number of nearby object routes that include a route segment that overlaps the tracking device process's expected route according to the route progression indicator. For example, the tracking device's expected route may include a route segment of A->B and the tracking device process determines that five out of six nearby object routes have a route segment of A->B.

The tracking device process computes an actual overlap percentage, which is the number of nearby object routes that include a route segment that overlaps the expected route relative to the total number of nearby object routes (e.g., 5/6=83%), and a determination is made as to whether the actual overlap percentage meets a required overlap percentage (decision 630). For example, the required overlap percentage may be set at 80% or may be dynamic in nature based upon the amount of nearby object routes received. If the actual overlap percentage fails to meet the required overlap percentage, decision 630 branches to the “No” branch, whereupon the tracking device process indicates that the tracking device's corresponding object has deviated from the object's expected route (step 632). In one embodiment, the tracking device process sends an audible signal to speaker 140. In another embodiment, the tracking device process sends a visual signal to display 140. In yet another embodiment, the tracking device process sends a wireless message via wireless transceiver 120 to a listening device. In yet another embodiment, the tracking device process generates multiple notifications discussed above.

On the other hand, if the tracking device process determines that the actual overlap percentage meets the required overlap percentage, decision 630 branches to the “Yes” branch, whereupon the tracking device process updates (increments) the route progression indicator at step 635 to point to the next route segment and loops back to step 605 to receive more data.

Referring back to decision 610, when the tracking device receives facility data, such as from a sorting facility's data transceiver, decision 610 branches to the “Facility Data” branch, whereupon the tracking device process compares the facility data against expected route waypoints relative to the route progression indicator (step 650). Referring to FIG. 3B, tracking device 100 compares facility data 380 (e.g., Memphis, Tenn.) with waypoints included in expected route 220.

The tracking device process determines whether the received facility data matches one of the expected route waypoints according to the route progression indicator (decision 655). If a match fails to occur, decision 655 branches to the “No” branch, whereupon the tracking device process generates a notification at step 657 (e.g., audible alert, visual alert, wireless message, etc.) and processing ends at 659.

On the other hand, if the facility data matches one of the expected route waypoints according to the route progression indicator, indicating that the object is currently at a sorting facility, decision 655 branches to the “Yes” branch, whereupon the tracking device process determines whether the object has arrived at the object's sorting facility destination (decision 660). If the tracking device process determines that the object has arrived at the object's sorting facility destination, decision 640 branches to the “Yes” branch, whereupon the tracking device process ends at 662.

On the other hand, if the tracking device process determines that the object has not arrived at the object's sorting facility destination, decision 860 branches to the “No” branch, whereupon the tracking device process starts a timer to monitor the amount of time that the tracking device remains at the sorting facility (step 665).

In one embodiment, the sorting facility transmits facility data at recurring intervals (e.g., every few minutes). Step 670 assumes such embodiment, and the tracking device process waits for an allotted time to check whether it receives additional facility data. A determination is made as to whether the tracking device process receives the facility data (decision 675). If the tracking device does not receive the facility data within the allotted amount of time, thus indicating that the tracking device's object has left the sorting facility, decision 675 branches to the “No” branch, whereupon the tracking device process clears the object data (step 676) and waits to receive more data corresponding to the next expected route segment.

On the other hand, if the tracking device process receives the facility data within the allotted time, decision 675 branches to the “Yes” branch, whereupon the tracking device process checks the timer to determine the amount of time that the tracking device's object has been at the facility (step 678). A determination is made as to whether the amount of time that the tracking device's object has been at the facility exceeds a threshold, such as six hours (decision 680). If the object has not been at the facility for an amount of time that exceeds the threshold, decision 680 branches to the “No” branch, whereupon the tracking device process loops back to wait for more facility data.

On the other hand, of the object has been at the facility for an amount of time that exceeds the threshold, decision 680 branches to the “Yes” branch, whereupon the tracking device process generates a notification at step 685 and processing ends at 690.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method for tracking objects, implemented by an information handling system, comprising:
receiving, at a tracking device attached to an object, a plurality of nearby object routes from a plurality of nearby tracking devices each attached to one of a plurality of nearby objects;
comparing, by the tracking device, an expected route corresponding to the object with the received plurality of nearby object routes; and
generating a notification, by the tracking device, that indicates the object is deviating from the expected route in response to the comparison.

2. The method of claim 1 wherein the comparing further comprises:
identifying an actual overlap percentage of the plurality of nearby object routes that include a nearby object route segment matching an expected route segment included in the expected route; and
determining that the actual overlap percentage fails to reach a required overlap percentage.

3. The method of claim 2 further comprising:
selecting the expected route segment, from a plurality of expected route segments, based upon a route progression indicator; and
for each of the plurality of nearby object routes, selecting the nearby route segment based upon the route progression indicator for which to match against the selected expected route segment.

4. The method of claim 1 wherein the notification provided by the tracking device is selected from the group consisting of an audio notification and a visual notification.

5. The method of claim 1 wherein the notification is a broadcast wireless message.

6. The method of claim 1 further comprising:
receiving facility data at the tracking device, wherein the receiving of the facility data indicates that the object is located at a facility;
comparing the facility data to one or more expected route waypoints included in the expected route; and
generating the notification in response to the facility data failing to match one or more of the expected route waypoints.

7. The method of claim 6 further comprising:
setting a timer in response to receiving the facility data;
receiving subsequent facility data subsequent to setting the timer;
in response to receiving the subsequent facility data, determining that the timer exceeds a facility timeframe threshold; and
generating a different notification, by the tracking device, in response to the determination.

8. The method of claim 1 wherein the expected route is stored in the tracking device.

9. An information handling system comprising:
one or more processors;
a memory coupled to at least one of the one or more processors;
one or more wireless transceivers accessible by at least one of the one or more transceivers;
a set of computer program instructions stored in the memory and executed by at least one of the processors in order to perform actions of:
receiving, at the information handling device attached to an object, a plurality of nearby object routes from a plurality of nearby tracking devices each attached to one of a plurality of nearby objects;
comparing, by the information handling device, an expected route corresponding to the object with the received plurality of nearby object routes; and
generating a notification, by the information handling device, that indicates the object is deviating from the expected route in response to the comparison.

10. The information handling system of claim 9 wherein the processors perform additional actions comprising:
identifying an actual overlap percentage of the plurality of nearby object routes that include a nearby object route segment matching an expected route segment included in the expected route; and
determining that the actual overlap percentage fails to reach a required overlap percentage.

11. The information handling system of claim 10 wherein the processors perform additional actions comprising:
selecting the expected route segment, from a plurality of expected route segments, based upon a route progression indicator; and
for each of the plurality of nearby object routes, selecting the nearby route segment based upon the route progression indicator for which to match against the selected expected route segment.

12. The information handling system of claim 9 wherein the notification provided by the information handling device is selected from the group consisting of an audio notification and a visual notification.

13. The information handling system of claim 9 wherein the notification is a broadcast wireless message.

14. The information handling system of claim 9 wherein the processors perform additional actions comprising:
receiving facility data at the information handling device, wherein the receiving of the facility data indicates that the object is located at a facility;
comparing the facility data to one or more expected route waypoints included in the expected route; and
generating the notification in response to the facility data failing to match one or more of the expected route waypoints.

15. The information handling system of claim 14 wherein the processors perform additional actions comprising:
setting a timer in response to receiving the facility data;
receiving subsequent facility data subsequent to setting the timer;
in response to receiving the subsequent facility data, determining that the timer exceeds a facility timeframe threshold; and
generating a different notification, by the information handling device, in response to the determination.

16. A computer program product stored in a computer readable storage medium, comprising computer program code that, when executed by an information handling system, causes the information handling system to perform actions comprising:
receiving, at the information handling device attached to an object, a plurality of nearby object routes from a plurality of nearby tracking devices each attached to one of a plurality of nearby objects;
comparing, by the information handling device, an expected route corresponding to the object with the received plurality of nearby object routes; and
generating a notification, by the information handling device, that indicates the object is deviating from the expected route in response to the comparison.

17. The computer program product of claim 16 wherein the information handling system performs further actions comprising:
identifying an actual overlap percentage of the plurality of nearby object routes that include a nearby object route segment matching an expected route segment included in the expected route; and
determining that the actual overlap percentage fails to reach a required overlap percentage.

18. The computer program product of claim 17 wherein the information handling system performs further actions comprising:
selecting the expected route segment, from a plurality of expected route segments, based upon a route progression indicator; and
for each of the plurality of nearby object routes, selecting the nearby route segment based upon the route progression indicator for which to match against the selected expected route segment.

19. The computer program product of claim 16 wherein the notification provided by the information handling device is selected from the group consisting of an audio notification and a visual notification.

20. The computer program product of claim 16 wherein the notification is a broadcast wireless message.
